(19) United States
(12) Patent Application Publication
(10) Pub. No.: US 2019/0260933 A1
(43) Pub. Date: Aug. 22, 2019

(54) IMAGE CAPTURING APPARATUS PERFORMING IMAGE STABILIZATION, CONTROL METHOD THEREOF, AND STORAGE MEDIUM

(71) Applicant: CANON KABUSHIKI KAISHA, Tokyo (JP)

(72) Inventor: Hiroyo Tanaka, Yokohama-shi (JP)

(21) Appl. No.: 16/277,857

(22) Filed: Feb. 15, 2019

(30) Foreign Application Priority Data
Feb. 19, 2018 (JP) 2018-027249

(51) Int. Cl. H04N 5/232

(52) U.S. Cl. CPC H04N 5/23258; H04N 5/23287

(57) ABSTRACT

An image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, comprises: a second shake detection sensor that detects shaking; an estimation circuit that estimates a shake correction amount to be used by the first image stabilization apparatus based on a shake signal from the second shake detection sensor; and a lens characteristics correction circuit that performs correction regarding lens characteristics in an image signal obtained by image-capturing in a state in which the first image stabilization apparatus has corrected shaking, based on the estimated shake correction amount.

### BACKGROUND OF THE INVENTION

### Field of the Invention

The present invention relates to an image capturing apparatus that performs image stabilization, a control method thereof, and a storage medium.

### Description of the Related Art

It is known that, in general, because a light amount decreases and aberration occurs in the periphery of an image sensor due to optical lens characteristics, the image quality of a subject image that is projected on the image sensor through an optical system decreases. Also, in the case where camera shake correction control is performed in an image capturing apparatus including an optical lens, because a camera shake correction lens, an image sensor, or the like moves according to the amount of vibration of the image capturing apparatus, the image quality further decreases in the periphery of the image sensor. With regard to such an issue, a technique has been proposed in which correction regarding the lens characteristics is performed according to the relative positions of the center of the image sensor and the optical axis center of the optical system (Japanese Patent No. 5736512).

Also, an image capturing apparatus that includes a plurality of camera shake correction driving apparatuses in order to deal with a larger camera shake by enlarging the driving range of a driving apparatus has appeared, and a technique has also been proposed in which marginal illumination is corrected in such an image capturing apparatus that includes a plurality of camera shake correction driving apparatuses (Japanese Patent Laid-Open No. 2016-167801).

In an image capturing apparatus described in Japanese Patent No. 5736512, optical distortion correction or shading correction is performed, by a camera shake correction apparatus, on a subject image captured by an image sensor according to the relative positions of the center of the image sensor and the optical axis center of a shooting optical system that have been moved. Degradation of image quality in the periphery of the image sensor due to relative positional movements of the camera shake correction lens, the image sensor, and the like can be reduced by using this technique.

On the other hand, the image capturing apparatus described in Japanese Patent Laid-Open No. 2016-167801 includes a lens driving apparatus that performs camera shake correction by moving the camera shake correction lens and an image sensor driving apparatus that performs camera shake correction by moving the image sensor. In this image capturing apparatus, when the camera shake correction is switched between correction performed by the lens driving apparatus and correction performed by the image sensor, the correction amount of marginal illumination of an image captured by the image sensor changes. With this configuration, the marginal illumination can be appropriately corrected according to the driving apparatus that is selected to perform camera shake correction.

Incidentally, when camera shake correction and correction regarding lens characteristics are performed in an image capturing apparatus that uses an interchangeable lens that includes a camera shake correction lens, the timing at which camera shake correction is performed is shifted from the timing at which correction regarding the lens characteristics is performed due to the time delay in communication between the interchangeable lens and the image capturing apparatus. When the timing shift between the camera shake correction and the correction regarding the lens characteristics is prominent, there is a possibility that image quality degrades, because image correction processing is performed in a state in which the image is excessively corrected or insufficiently corrected. In this regard, the delay time in communication between the interchangeable lens and the image capturing apparatus is not taken into consideration in Japanese Patent No. 5736512. Also, in Japanese Patent Laid-Open No. 2016-167801, although camera shake correction in which the lens driving apparatus and the image sensor driving apparatus are driven at the same time is not considered, because the lens characteristics correction circuit is provided on the image capturing apparatus side, measurement information needs to be transmitted from the interchangeable lens to the image capturing apparatus, and a control value needs to be transmitted from the image capturing apparatus to the interchangeable lens. That is, when correction regarding the lens characteristics is performed, communication between the interchangeable lens and the image capturing apparatus needs to be performed, and the correction is influenced by communication delay, but the communication delay is not taken into consideration.

In this way, in an image capturing apparatus that uses an interchangeable lens that includes a camera shake correction lens, it is difficult to perform correction regarding lens characteristics in real time according to the state of a camera shake correction apparatus while performing camera shake correction using the camera shake correction lens. That is, there are cases where an image is excessively or insufficiently corrected due to the communication delay when a correction amount is transmitted, depending on the timing, and an appropriate correction result cannot be obtained.

### SUMMARY OF THE INVENTION

Embodiments of the present invention provide a technique in which, when correction regarding lens characteristics is performed in a camera main body while using a camera shake correction apparatus on an interchangeable lens side, at least the influence of delay in communication between the interchangeable lens and the camera main body is reduced.

Some embodiments of the present invention provide an image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, comprising: a second shake detection sensor that detects shaking; an estimation circuit that estimates a shake correction amount to be used by the first image stabilization apparatus based on a shake signal from the second shake detection sensor; and a lens characteristics correction circuit that performs correction regarding lens characteristics in an image signal obtained by image-capturing in a state in which the first image stabilization apparatus has corrected shaking, based on the estimated shake correction amount.

Some embodiments of the present invention provide, a control method of an image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, comprising: detecting shaking using a second shake detection sensor; estimating a shake correction amount to be used by the first image stabilization apparatus based on a shake signal from the second shake detection sensor; and performing correction regarding lens characteristics in an image signal obtained by image-capturing in a state in which the first image stabilization apparatus has corrected shaking, based on the estimated shake correction amount.

Some embodiments of the present invention provide, a non-transitory computer-readable storage medium storing a program for causing a computer to execute a control method of an image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, the control method comprising: detecting shaking using a second shake detection sensor; estimating a shake correction amount to be used by the first image stabilization apparatus based on a shake signal from the second shake detection sensor; and performing correction regarding lens characteristics in an image signal obtained by image-capturing in a state in which the first image stabilization apparatus has corrected shaking, based on the estimated shake correction amount.

According to embodiments of the present invention, when correction regarding lens characteristics is performed in a camera main body while using a camera shake correction apparatus on an interchangeable lens side, at least the influence of delay in communication between the interchangeable lens and the camera main body can be reduced.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIGS. 1A and 1B are diagrams illustrating an exemplary configuration of a digital camera as an example of an image capturing apparatus according to a first embodiment.

FIG. 2 is a diagram for describing a rotation axis of the digital camera according to the first embodiment.

FIG. 3 is a flowchart illustrating series of operations of camera shake correction processing in the digital camera according to the first embodiment.

FIG. 4 is a flowchart illustrating series of operations of camera shake correction processing in an interchangeable lens according to the first embodiment.

FIGS. 5A and 5B are diagrams illustrating time series waveforms of a camera shake correction amount according to the first embodiment.

FIGS. 6A and 6B are diagrams illustrating other time series waveforms of the camera shake correction amount according to the first embodiment.

FIGS. 7A to 7C are diagrams for describing correction regarding marginal illumination characteristics according to the first embodiment.

FIG. 8 is a flowchart illustrating a series of operations of correction processing regarding lens characteristics according to the first embodiment.

FIGS. 9A to 9C are diagrams for describing distortion correction according to a second embodiment.

### DESCRIPTION OF THE EMBODIMENTS

### First Embodiment

Hereinafter, exemplary embodiments of the present invention will be described in detail with reference to the drawings. Note that the following describes an example in which a digital camera to which an interchangeable lens can be attached and in which image stabilization is possible is used as an image capturing apparatus. However, the present embodiment is not limited to digital cameras, but can also be applied to other devices to which an interchangeable lens can be attached and in which image stabilization is possible. These devices may include mobile phones including a smartphone, a game machine, a medical device, a device in an on-vehicle system, a robot device that makes determination based on a captured image, and a flying device such as a drone, for example.

Configuration of Image Capturing System

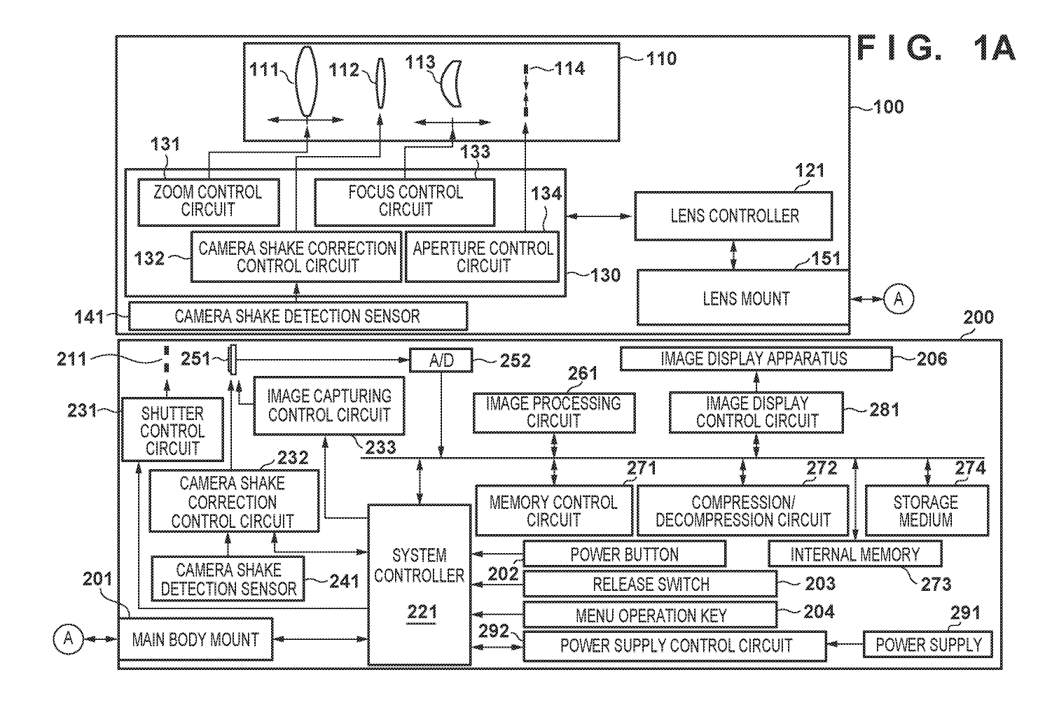

FIG. 1A is a block diagram illustrating an exemplary functional configuration of an image capturing system including a digital camera 200 and an interchangeable lens 100, which serves as an example of the image capturing apparatus according to the present embodiment. Note that one or more functional blocks shown in FIGS. 1A and 1B may be realized by hardware such as an ASIC or a programmable logic array (PLA), or may be realized by a programmable processor such as a CPU or an MPU executing software. Also, such functional blocks may also be realized by a combination of software and hardware. Accordingly, in the following description, even in the case where processing is described as being performed by different functional blocks, these blocks can be realized by the same hardware.

In the present embodiment, an example will be described in which the digital camera 200 performs correction processing regarding lens characteristics in which a camera shake is corrected by driving a camera shake correction lens in the interchangeable lens 100 and an image sensor in the digital camera 200 at the same time.

The interchangeable lens 100 generally includes an optical block 110, a lens control block 130, a lens mount 151, and a lens controller 121. The optical block 110 includes a zoom lens 111, a camera shake correction lens 112, a focus adjustment lens 113, and an aperture 114. The zoom lens 111 is configured to be reciprocally movable, and reciprocally moves according to control performed by a zoom control circuit 131 so as to enlarge or shrink an optical image formed on an image sensor of the digital camera 200. The camera shake correction lens 112 changes its position according to a control performed by a camera shake correction control circuit 132 so as to correct camera shake. The focus adjustment lens 113 is configured to be reciprocally movable, and reciprocally moves according to a control performed by a focus control circuit 133 so as to change the focal position. The aperture 114 changes its aperture diameter according to a control performed by an aperture control circuit 134 so as to change the amount of light to be incident on the image sensor of the digital camera 200.

The lens control block 130 includes control circuits for driving the constituent members included in the optical block 110, and includes the zoom control circuit 131, the camera shake correction control circuit 132, the focus control circuit 133, the aperture control circuit 134, and the like. These control circuits each control the driving of a corresponding lens in the optical block 110 according to an instruction from the lens controller 121.

The lens controller 121 includes a CPU (or MPU), a ROM, and a RAM, for example, and controls overall operations of the interchangeable lens 100 and data transfer between the units of the interchangeable lens 100 by deploying a program stored in the ROM to the RAM and executing the deployed program. Also, the lens controller 121 may execute some of or all of the computations to be executed by the later-described camera shake correction control circuit 132 in place of the camera shake correction control circuit 132.

A camera shake detection sensor 141 includes an angular velocity sensor (gyroscope) or the like, for example, and detects a vibration applied to the interchangeable lens 100. The camera shake correction control circuit 132 corrects camera shake based on the output of the camera shake detection sensor 141. The lens mount 151 can be mechanically and electrically connected to the digital camera 200, and can receive control commands, other pieces of data, and power from the digital camera 200.

Next, the digital camera 200 will be described. The digital camera 200 is a main body of the image capturing apparatus, and includes the following constituent elements. An image sensor 251 has a configuration in which a plurality of pixels each having a photoelectric conversion element are arrayed two dimensionally, converts an optical image incident thereon via the interchangeable lens 100 to an electrical signal, which is an analog image signal, and outputs the analog image signal. An image capturing control circuit 233 controls a timing at which the image sensor 251 outputs an image signal and the like. The image sensor 251 includes a driving apparatus for changing the position of the image sensor relative to an optical axis. The driving apparatus changes the position of the image sensor relative to the optical axis according to a position control signal generated by a camera shake correction control circuit 232, and as a result, the image sensor 251 can exert an image stabilization function.

The A/D converter 252 converts the analog image signal output from the image sensor 251 to a digital image signal. The digital image signal output from the A/D converter 252 is stored in an internal memory 273 via a bus. A memory control circuit 271 controls writing of data to the internal memory 273 and reading out of data from the internal memory 273 according to an instruction from a system controller 221. In addition, the memory control circuit 271 controls the A/D converter 252, an image processing circuit 261, and a compression/decompression circuit 272 so as to control recording of data to a storage medium 274.

The image processing circuit 261 includes computation circuits such as an ASIC or a GPU for image processing, and performs predetermined processing such as pixel interpolation processing or color conversion processing on an image signal from the A/D converter 252 or the memory control circuit 271. The predetermined processing includes later-described correction processing regarding lens characteristics. Note that some of or all of the processing executed by the image processing circuit 261 may be executed by the system controller 221 in place of the image processing circuit 261.

A shutter control circuit 231 controls operations of a shutter 211 according to a trigger signal from the system controller 221. The shutter 211 causes a shutter to operate according to the control of the shutter control circuit 231.

A camera shake detection sensor 241 includes an angular velocity sensor (gyrosensor) or the like, for example, and detects vibration applied to the digital camera 200. The camera shake correction control circuit 232 corrects camera shake based on an output from the camera shake detection sensor 241.

An image display control circuit 281 controls an image display apparatus 206 constituted by a TFT, an LCD, or the like so as to display a moving image, a still image, a menu screen, and the like. A display image signal written to the internal memory 273 is sent to the image display apparatus 206 via the image display control circuit 281, and the image display apparatus 206 performs display. The internal memory 273 includes a volatile memory such as a semiconductor memory, for example, and is an internal memory for storing captured still images and moving images. Also, the internal memory 273 can also be used as a work area of the system controller 221. The compression/decompression unit 272 includes a compression/decompression circuit for compressing and decompressing an image signal, reads out an image stored in the internal memory 273, performs compression processing or decompression processing on the read-out image, and again writes resultant data of the processing to the internal memory 273.

A main body mount 201 can be mechanically and electrically connected to the interchangeable lens 100, and supplies control signals from the system controller 221 and power from a power supply 291 to the interchangeable lens 100 via the lens mount 151.

The system controller 221 includes a computation circuit such as a CPU (or MPU), deploys a program recorded in a storage medium 274 to the internal memory 273, executes the deployed program, and controls the units of the digital camera 200 and data transfer between the units. The storage medium 274 is a storage medium such as a memory card for recording shot images, and is constituted by a semiconductor memory, a magnetic disc, or the like. The storage medium 274 stores a program for the system controller and constants for operation.

A power button 202, a release switch 203, and a menu operation key 204 are operation members for inputting various operation instructions to the system controller 221, and are each constituted by a switch, a dial, or a touch panel, or a combination thereof. The power button 202 is an operation member that generates a trigger for powering on or off the digital camera 200. The release switch 203 is an operation member for generating a trigger signal for causing a shutter to operate in order to record a still image, and a trigger signal for starting or stopping moving image recording. The menu operation key 204 is an operation member for generating a signal for configuring settings of the image capturing apparatus.

A power supply control circuit 292 supplies, triggered by a signal generated by the power button 202, power from the power supply 291 to the units of the digital camera 200.

Configuration Relating to Camera Shake Correction Processing and Series of Operations

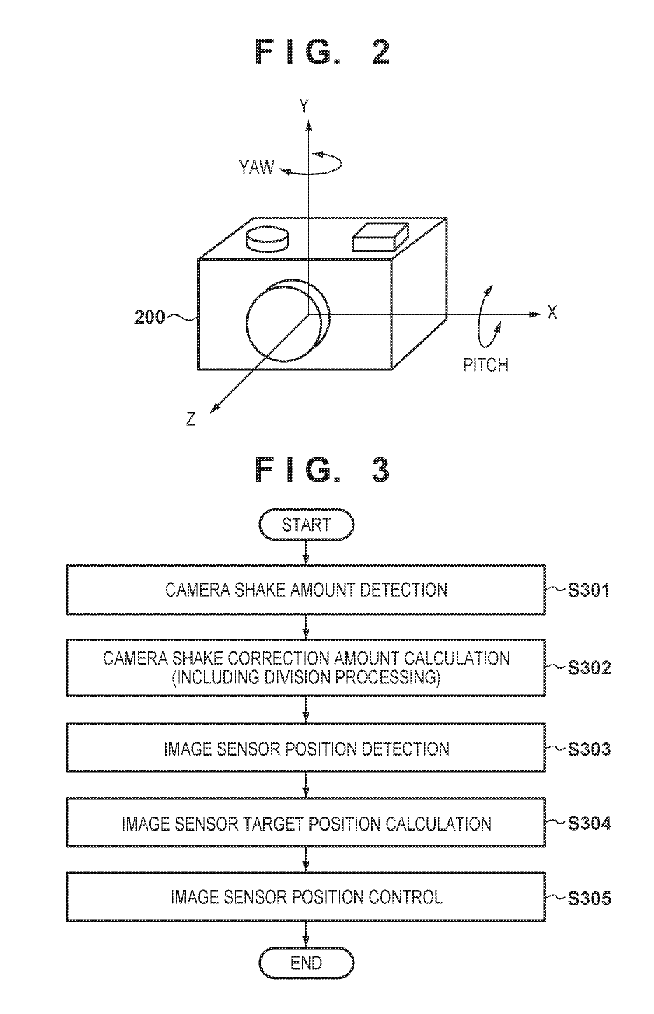

First, a series of operations relating to camera shake correction processing in which camera shake correction is performed by controlling the position of the image sensor 251 will be described, with reference to FIG. 3. Also, a series of operations relating to the camera shake correction processing will be described, with reference to detailed exemplary functional configurations of the camera shake correction control circuit 132 of the interchangeable lens 100 and the camera shake correction control circuit 232 of the digital camera 200 shown in FIG. 1B.

Note that this processing is realized by the system controller 221 of the digital camera 200 deploying a program recorded in the storage medium 274 to the internal memory 273, executing the deployed program, and controlling the units of the digital camera 200. Also, the series of operations shown in FIG. 3 is started when a user holds the digital camera 200 by hand and starts shooting, or prepares to shoot, a given subject.

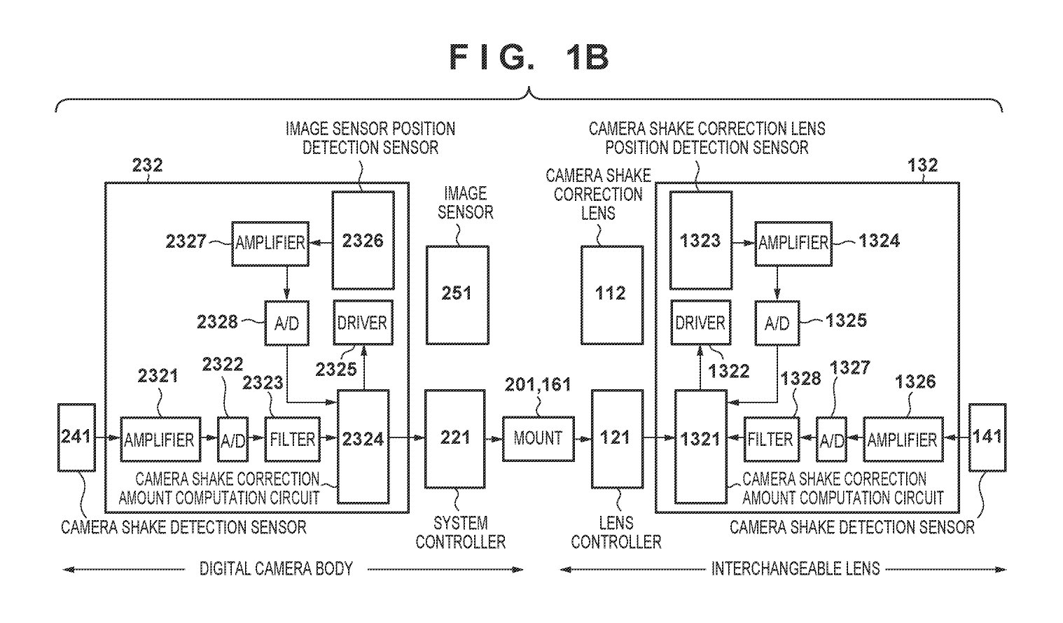

In step S301, the camera shake detection sensor 241 detects an amount of camera shake applied to the digital camera 200, which is represented by an angular velocity, for example The camera shake detection sensor 241 can detect vibration in a pitch direction (rotation about a pitch axis) and in a yaw direction (rotation about a yaw axis) in the digital camera 200, in an orthogonal coordinate system as shown in FIG. 2, for example.

In step S302, the camera shake correction control circuit 232 calculates a camera shake correction amount. Specifically, first, a camera shake signal generated by the camera shake detection sensor 241 is input to the camera shake correction control circuit 232. An amplifier 2321 acquires the camera shake signal from the camera shake detection sensor 241, and amplifies the acquired camera shake signal by a predetermined magnification. An A/D converter 2322 converts the camera shake signal that has been amplified by the amplifier 2321 from an analog signal to a digital signal. A filter 2323 performs filter processing on the camera shake signal that has been converted to a digital signal by the A/D converter 2322 such that a portion of the signal is cut off at a predetermined cut-off frequency that has been set. For example, a low pass filter is used to remove high frequency noise, or a high pass filter is used to remove an offset component.

Next, the filter 2323 divides the obtained camera shake signal into a component that is to be corrected by driving the image sensor 251 and a component that is to be corrected by driving the camera shake correction lens 112. Specifically, a low frequency component, of the camera shake signal, that is lower than a predetermined frequency corresponds to the component that is to be corrected by the camera shake correction control circuit 132 of the interchangeable lens 100. On the other hand, a high frequency component corresponds to the component that is to be corrected by the camera shake correction control circuit 232 of the digital camera 200.

Note that this division is for performing camera shake correction by sharing the correction between the interchangeable lens 100 and the digital camera 200. As will be described later, a similar camera shake signal is also generated by the camera shake detection sensor 141 in the interchangeable lens 100. Also, similarly, a component that is to be corrected by driving the image sensor 251, and a component that is to be corrected by driving the camera shake correction lens 112 are obtained. Then, the camera shake correction lens 112 and the image sensor 251 are respectively driven on the interchangeable lens 100 side and the digital camera 200 side using independently obtained similar camera shake correction amounts.

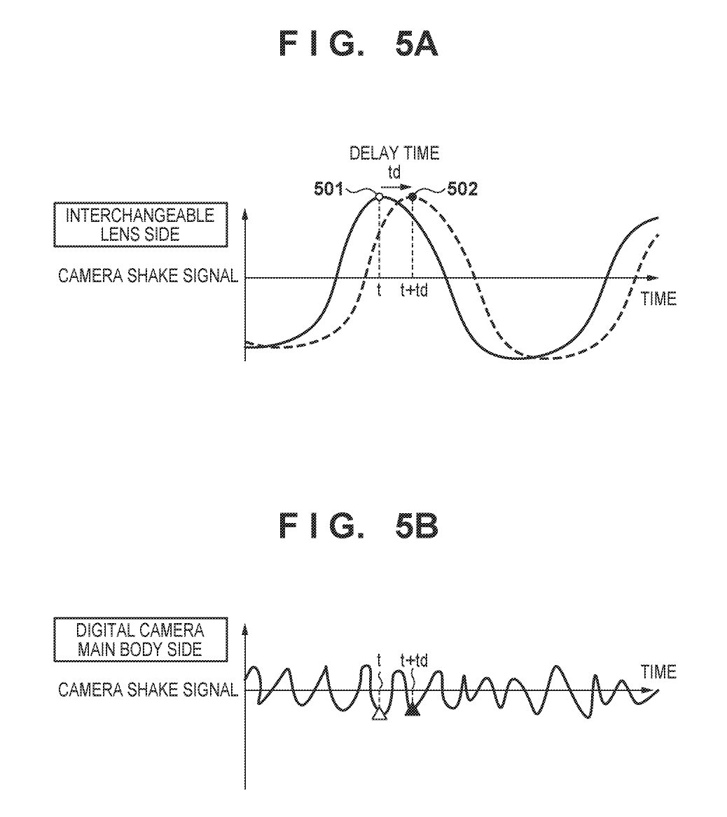

FIGS. 5A and 5B show an example in the case where a camera shake signal is divided at a predetermined frequency. Note that, in each diagram, the horizontal axis shown the time, and the vertical axis shows the signal value of the camera shake signal. The solid line shown in FIG. 5A shows the camera shake signal for correction to be performed by the camera shake correction control circuit 132, which is obtained by extracting a low frequency component, of the total camera shake signal, that is lower than a predetermined frequency. On the other hand, the solid line shown in FIG. 5B shows the camera shake signal for correction to be performed by the camera shake correction control circuit 232, and shows a high frequency component, of the total camera shake signal, that is equal to or higher than the predetermined frequency. As a result of dividing the camera shake signal in this way, a large camera shake can be corrected relative to a case where camera shake correction is performed using one driving apparatus.

The filter 2323, upon completing division of the camera shake signal, integrates the high frequency component obtained by the division in order to calculate the camera shake correction amount to be applied to the digital camera 200.

Next, the camera shake correction amount computation circuit 2324 adjusts the camera shake correction amount (based on which the image sensor is to be driven) by magnifying the camera shake correction amount obtained by the filter 2323 based on positions of the optical members such as the zoom lens and a focus lens, and a focal distance and a magnification obtained from these positions. The reason for this processing being performed is to deal with the change in sensitivity of camera shake correction on the imaging plane relative to a stroke of the camera shake correction due to the change in optical parameters such as a focal distance and a magnification.

In step S303, the camera shake correction control circuit 232 detects the current position of the image sensor. An image sensor position detection sensor 2326 that includes a sensor for detecting the position of the image sensor, which is a movable unit, outputs a position signal that indicates the position of the image sensor from the sensor. An amplifier 2327 amplifies the detected position signal by a predetermined magnification, and then an A/D converter 2328 converts the amplified position signal to a digital signal, and inputs the digital signal to the camera shake correction amount computation circuit 2324.

In step S304, the camera shake correction control circuit 232 calculates the target position of the image sensor 251. Specifically, the camera shake correction amount computation circuit 2324 calculates the target position of the image sensor 251 based on the camera shake correction amount for correction to be performed by driving the image sensor 251, which is obtained in step S302, and the position of the image sensor 251, which is obtained in step S303. Then, the position control signal indicating the target position is generated.

In step S305, the camera shake correction control circuit 232 controls the position of the image sensor 251. Specifically, a driver 2325 causes a drive current to flow to a camera shake correction actuator for driving the image sensor 251, according to the position control signal generated in step S304. The camera shake correction actuator, driven by the received current, drives the image sensor 251, which is a movable unit. The camera shake correction control circuit 232 regularly repeats processing relating to the camera shake correction control, and then ends the processing.

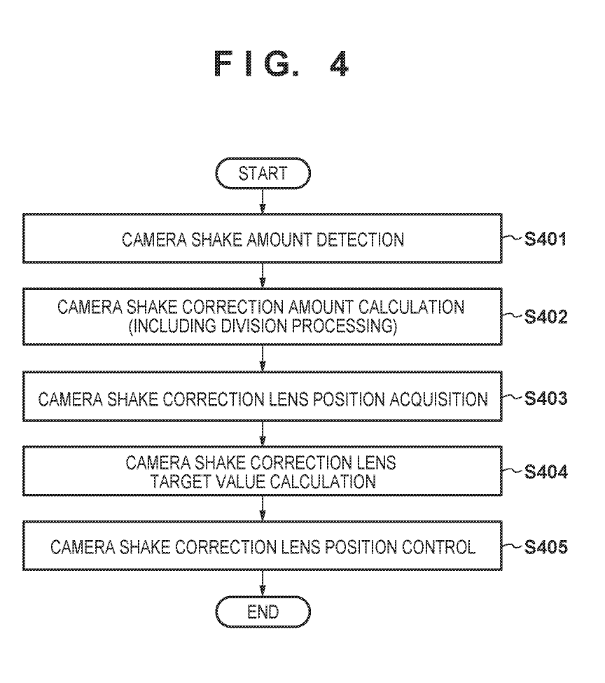

Next, the camera shake correction control in the interchangeable lens 100 will be described with reference to FIG. 4. Note that this processing is realized by the lens controller 121 of the interchangeable lens 100 deploying a program stored in the ROM to the RAM, executing the deployed program, and controlling the units of the interchangeable lens 100.

In step S401, the camera shake detection sensor 141 detects a camera shake amount. The camera shake detection sensor 141 generates a camera shake signal, which indicates a camera shake applied to the interchangeable lens 100, that shows an angular velocity measured by an angular velocity sensor or the like mounted on the interchangeable lens 100.

In step S402, the camera shake correction control circuit 132 calculates a camera shake correction amount. Specifically, first, the camera shake correction control circuit 132 acquires the camera shake signal output from the camera shake detection sensor 141. An amplifier 1326 amplifies the camera shake signal input to the camera shake correction control circuit 132 by a predetermined magnification. An A/D converter 1327 converts the camera shake signal that has been amplified by the amplifier 1326 to a digital signal. A filter 1328 performs filter processing on the camera shake signal that has been converted to the digital signal by the A/D converter 1327. Specifically, the filter 1328 cuts off a portion of the camera shake signal at a predetermined cut-off frequency, which has been set. For example, a low pass filter is used to remove high frequency noise, or a high pass filter is used to remove an offset component.

Next, the filter 1328 divides the obtained camera shake signal into a component that is to be corrected by driving the image sensor 251 and a component that is to be corrected by driving the camera shake correction lens 112. With respect to the division method, as described above in step S302, the total camera shake signal is divided into a low frequency component and a high frequency component relative to the predetermined frequency. The filter 1328, upon completing the division processing, integrates the low frequency component, which has been obtained by division, in order to calculate the camera shake correction amount to be applied to the interchangeable lens 100.

Next, the camera shake correction amount computation circuit 2324 adjusts the camera shake correction amount by magnifying the camera shake correction amount obtained by the filter 2323 based on positions of the optical members such as the zoom lens and a focus lens, and a focal distance and a magnification obtained from these positions. As described above, the reason for this processing being performed is to deal with the change in sensitivity of camera shake correction on the imaging plane relative to a stroke of the camera shake correction due to the change in optical parameters such as a focal distance and a magnification.

In step S403, the camera shake correction control circuit 132 acquires the position of the camera shake correction lens 112. Specifically, a camera shake correction lens position detection sensor 1323 detects the position of the camera shake correction lens 112 that is to be driven, and outputs a position signal indicating the detected position. An amplifier 1324 amplifies the position signal by a predetermined magnification, and an A/D converter 1325 converts the position signal to a digital signal, and outputs the digital signal to a camera shake correction amount computation circuit 1321.

In step S404, the camera shake correction control circuit 132 calculates the target position of the camera shake correction lens. The camera shake correction amount computation circuit 1321 calculates, similarly to the case where the image sensor 251 is to be driven, a position control signal based on the camera shake correction amount (by which the camera shake correction lens 112 is to be driven for performing correction) obtained in step S402 and the position signal acquired in step S403.

In step S405, a driver 1322 causes a drive current to flow to a correction actuator, which is not illustrated, for driving the camera shake correction lens 112 according to the position control signal calculated in step S404. The camera shake correction actuator is driven by this current so as to drive the camera shake correction lens 112. Note that the camera shake correction actuator may be included in the camera shake correction control circuit 132. The camera shake correction control circuit 132 regularly repeats processing relating to the camera shake correction control, and then ends the processing.

In this way, the digital camera 200 and the interchangeable lens 100 independently divide the camera shake signals obtained by the respective camera shake detection sensors, and calculate correction amounts for controlling the positions of the image sensor and the correction lens, respectively. Here, the digital camera 200 and the interchangeable lens 100 independently divide the camera shake signals based on a predetermined division method for the camera shake signal. However, a configuration may be adopted in which the lens mount 151 included in the digital camera 200 and the main body mount 201 included in the interchangeable lens 100 communicate information regarding the division methods of the respective camera shake correction driving apparatuses, and switch the division method as necessary. For example, if information or the like regarding the division method is exchanged when the frequency at which the camera shake signal is to be divided is changed according to the shooting focal distance, or the division method is changed according to the shooting scene, adaptive control can be realized.

Here, the features of the present embodiment will be described with reference to FIGS. 5A and 5B. In the present embodiment, because the digital camera 200 and the interchangeable lens 100 need not communicate the camera shake correction amount, there is an advantage in that camera shake correction is not influenced by a communication delay.

First, a case is considered where the digital camera 200 transmits a camera shake signal to the interchangeable lens 100 via communication between the interchangeable lens 100 and the digital camera 200. In FIG. 5A, the camera shake signal of the interchangeable lens 100 at time t that is calculated by the camera shake correction control circuit 232 on the digital camera 200 side is denoted by a dot 501. Assume that this camera shake signal is transmitted to the interchangeable lens via communication, and it takes time td for this communication, the camera shake correction lens 112 is actually driven at about time t+td. This timing is indicated by a dot 502. Similarly, if the camera shake signal is delayed by a fixed communication time td, the camera shake correction lens 112 is driven using the camera shake signal indicated by the broken line shown in FIG. 5A. That is, the driving apparatus that receives the camera shake signal via communication performs camera shake correction at a delayed timing.

In contrast, in the present embodiment, the digital camera 200 and the interchangeable lens 100 independently obtains respective camera shake correction amounts, and the camera shake correction amounts are not communicated, and therefore, there is no communication delay. That is, there is no time difference between the camera shake correction performed by the digital camera 200 and the camera shake correction performed by the interchangeable lens 100, and each camera shake correction can be performed in approximately real time.

Heretofore, a case has been described where the total camera shake signal is divided at a predetermined frequency, the high frequency region is corrected by the image sensor 251, and the low frequency region is corrected by the camera shake correction lens 112. On the other hand, the high frequency side relative to a predetermined frequency may be used for camera shake correction control of the camera shake correction lens 112, and the low frequency side relative to the predetermined frequency may be used for camera shake correction control of the image sensor 251. It is desirable that the total camera shake signal is appropriately divided and allocated according to the control resolution, the movable range in camera shake correction, and the characteristics of detection elements.

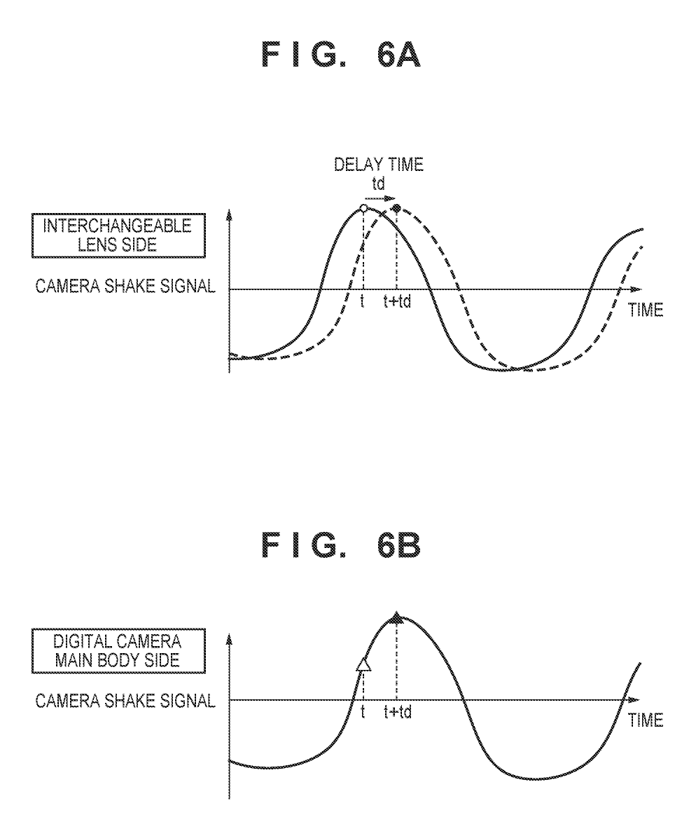

Also, the division method is not limited to the method of dividing at a predetermined frequency, and another division method may be used. For example, FIGS. 6A and 6B show an example of the case where the camera shake signal is divided at a predetermined rate. In FIGS. 6A and 6B, similarly to FIGS. 5A and 5B, the horizontal axis shows the time, and the vertical axis shows the camera shake signal. The solid line shown in FIG. 6A shows a component of the camera shake signal for correction to be performed in the interchangeable lens 100. The component is obtained by multiplying the total camera shake signal by a predetermined ratio. Also, the solid line shown in FIG. 6B shows a component of the camera shake signal for correction to be performed using the image sensor 251. The component is obtained by subtracting the component for correction to be performed in the interchangeable lens 100 from the total camera shake signal.

As a result of adopting the configuration in which a plurality of driving apparatuses share the camera shake correction, the influence of delays between the plurality of driving apparatuses can be reduced, and as a result, a large camera shake can be corrected and a long time shooting can be realized.

Correction Regarding Lens Characteristics

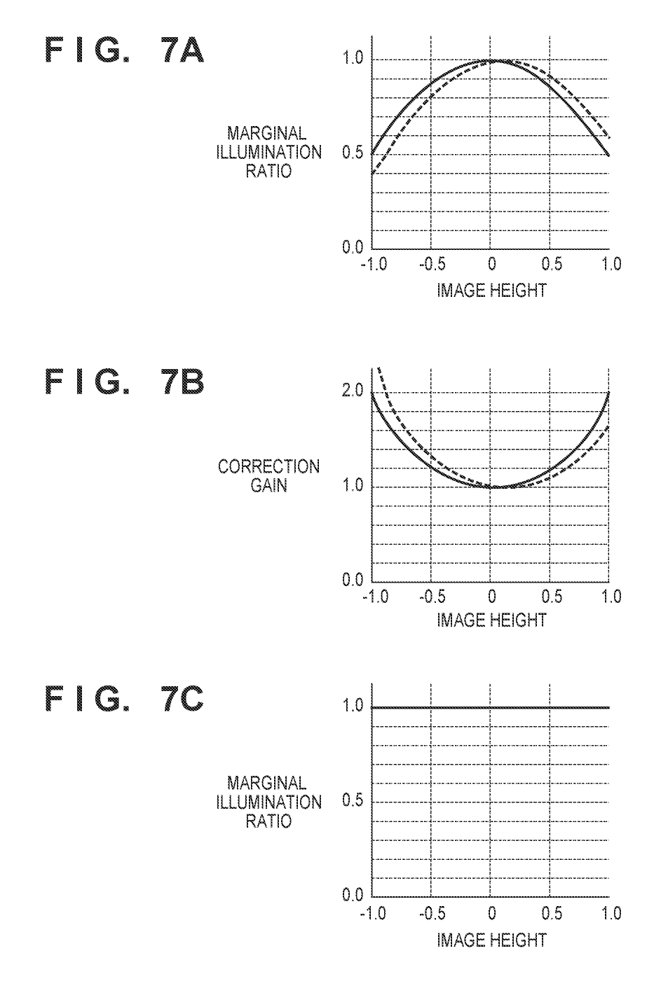

In the present embodiment, a case where marginal illumination is corrected will be described as an example of the case where correction regarding lens characteristics is performed. Marginal illumination characteristics when the camera shake correction lens 112 and the image sensor 251 are fixed at the respective central positions are as shown by the solid line shown in FIG. 7A. Note that the horizontal axis shows the image height, and the vertical axis shows the light amount ratio. That is, the characteristics show characteristics in which, when the light amount at the center of the optical system (that is, the position at which the image height is 0) is defined as 1.0, the light amount decreases as separating from the optical center. Note that a description regarding the dotted line shown in FIG. 7A will be given later when correction regarding the marginal illumination according to the position of a camera shake correction movable unit is described.

On the other hand, the solid line shown in FIG. 7B shows gain characteristics for performing correction regarding the marginal illumination shown in FIG. 7A. The image processing circuit 261 amplifies an input signal according to the image height and the correction gain in order to perform marginal illumination correction. The gain for performing the marginal illumination correction is stored in a RAM of the lens controller 121, for example, in the interchangeable lens 100, as table data showing gains for respective states of the optical system including the zoom lens, the focus lens, the aperture, and the like. The digital camera 200, when powered on, receives the gain table data from the lens controller 121, and temporarily stores the data in the internal memory 273. The image processing circuit 261 changes the parameters to be used in the marginal illumination correction according to the stored gain table data, the sensor size of the image sensor 251, design values of the mount and the like, and the state of the optical system. Note that a case has been described where the gain for marginal illumination correction is stored in the interchangeable lens 100 before power-on, but the gain may already be stored in the digital camera 200 prior to power-on. The solid line shown in FIG. 7C shows marginal illumination characteristics after marginal illumination correction has been performed. It is desirable that the characteristics shown in FIG. 7C show characteristics in which the marginal illumination ratio is constant (1.0, for example) regardless of the image height.

Correction Processing Regarding Lens Characteristics According to Position of Camera Shake Correction Movable Unit

The camera shake correction processing is processing in which the camera shake correction control circuit 132 changes the position of the camera shake correction lens 112 according to the camera shake amount, for example. Therefore, if the camera shake correction is enabled, correction regarding the lens characteristics need to be performed according to the position of the camera shake correction lens 112.

For example, marginal illumination characteristics when relative positions of the interchangeable lens 100 and the digital camera 200 are changed as a result of the camera shake correction being performed are shown by the broken line in FIG. 7A. When marginal illumination characteristics change due to the change in the relative positions of the interchangeable lens 100 and the digital camera 200, as shown by the broken line in FIG. 7A, gains for marginal illumination correction corresponding to the broken line shown in FIG. 7A need to be applied, as shown by the broken line in FIG. 7B. That is, a reference point (position at image height 0) moves according to the shake correction amount, and a larger correction value is applied as the distance from the reference point increases. When the input signal is corrected using the gain shown in FIG. 7B, a correction result in which the marginal illumination ratio is constant (1.0, for example) regardless of the image height, as shown by the solid line shown in FIG. 7C, can be obtained.

However, if the position of the camera shake correction lens 112 to be used in marginal illumination correction is different from the actual position of the camera shake correction lens 112 due to the communication delay, the correction gain characteristics to be applied shifts from the correction gain characteristics that should be applied. Therefore, excessive correction is performed in some portions, and correction is insufficient in other portions. As a result, a correction result in which the marginal illumination ratio is constant, as shown in FIG. 7C, cannot be obtained. That is, if the camera shake correction amount is acquired as needed by performing communication between the digital camera 200 and the interchangeable lens 100, excessive correction and insufficient correction are incurred in the correction regarding lens characteristics.

In contrast, in the present embodiment, the camera shake correction amount of the interchangeable lens 100 can be estimated using the camera shake detection sensor 241 included in the digital camera 200 without communicating the camera shake correction amount between the digital camera 200 and the interchangeable lens 100. That is, the digital camera 200 and the interchangeable lens 100 divide respective camera shake signals at a predetermined frequency, and driving apparatuses respectively control the image stabilization mechanisms according to the corresponding components of the divided camera shake signals. Therefore, the digital camera 200 can calculate not only a component to be used for driving the image sensor 251, but also a component to be used by the interchangeable lens 100 for driving the camera shake correction lens 112. That is, the digital camera 200 estimates the shake correction amount to be applied to the camera shake correction lens 112 of the interchangeable lens 100 based on the camera shake signal from the camera shake detection sensor 241.

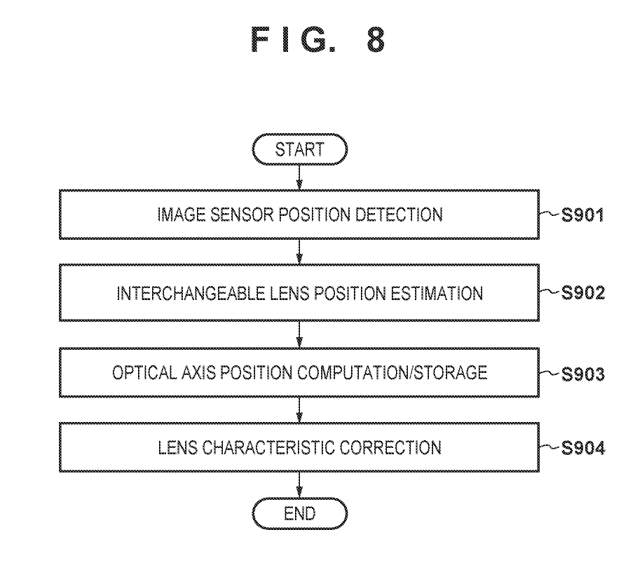

A series of operations relating to the correction processing regarding lens characteristics according to the position of the lens controlled by the camera shake correction control circuit 132 will be described with reference to FIG. 8. Note that this processing is realized by the system controller 221 deploying a program recorded in the storage medium 274 to the internal memory 273, executing the program, and controlling the units of the digital camera 200.

In step S901, the system controller 221 detects the position of the image sensor 251 via the camera shake correction control circuit 132. Specifically, the image sensor position detection sensor 2326 generates a signal indicating the position of the image sensor. For example, the target position to which the position of the image sensor 251 is to be controlled, which is used in step S304 described above, may be used as the position of the image sensor 251.

In step S902, the system controller 221 estimates the position of the camera shake correction lens 112 included in the interchangeable lens 100. Specifically, the camera shake signal to be used for correction performed by the image sensor 251 at time t, which is acquired in step S302, is denoted by TargetIIS(t), the camera shake signal to be used for correction performed by the camera shake correction lens 112 at time t is denoted by TargetOIS(t). Here, if the total camera shake signal is denoted by TotalTarget(t), TargetOIS(t) is as follows.

TargetOIS(t)=TotalTarget(t)−TargetIIS(t)

Here, it is assumed that the camera shake correction lens can move following the camera shake signal TargetOIS(t), and the camera shake detection sensor 241 included in the digital camera 200 and the camera shake detection sensor 141 included in the interchangeable lens 100 detect approximately the same camera shake amount. With this, based on the camera shake signal detected by the camera shake detection sensor 241 included in the digital camera 200, (the camera shake correction amount of the camera shake correction lens 112 can be obtained, and as a result) the position of the camera shake correction lens 112 can be estimated.

In step S903, the system controller 221 computes the optical axis position based on the position of the image sensor obtained in step S901 and the position of the camera shake correction lens obtained in step S902, and stores the optical axis position in the internal memory 273.

In step S904, the image processing circuit 261 obtains the correction gain with respect to marginal illumination based on the position of the image sensor 251 stored in the internal memory 273 and the estimated position of the camera shake correction lens 112. Then, correction of the marginal illumination at shooting is performed on the image signal obtained in a state in which the image sensor 251 and the camera shake correction lens 112 are at the respective positions for correcting the camera shake. Note that, in the case where a plurality of driving apparatuses for camera shake correction are present, as in the present embodiment, there are cases where the marginal illumination characteristics differ depending on the driving apparatus. In this case, a table in which correction gain characteristics of marginal illumination are determined in advance according to the position is provided for each of the image sensor 251 and the camera shake correction lens 112, and processing for correcting marginal illumination may be performed according to the respective positions, for example. The system controller 221, upon the image processing circuit 261 completing the processing for correcting marginal illumination, ends this series of processing.

As described above, in the present embodiment, the position of the camera shake correction lens that is controlled on the interchangeable lens 100 side is estimated, and a correction gain for performing correction regarding lens characteristics is applied considering the estimated position of the camera shake correction lens 112. Accordingly, when the camera shake correction is performed in each of the interchangeable lens 100 and the digital camera 200, correction regarding the lens characteristics can be appropriately performed without being influenced by the delay time in communication therebetween. That is, in the case where correction regarding lens characteristics is performed in the camera main body while using at least the camera shake correction apparatus on the interchangeable lens side, the influence of a delay in communication between the interchangeable lens and the camera main body can be reduced.

### Second Embodiment

Next, a second embodiment will be described. In the first embodiment, a case where correction regarding marginal illumination of the lens characteristics is performed has been described as an example. In the present embodiment, a case where distorted aberration of the lens characteristics is corrected (simply referred also as “distortion correction”) will be described as an example. The shooting optical system included in the interchangeable lens 100 has optical aberration, and distortion occurs in a peripheral portion of an image formed on the image sensor 251 due to this optical aberration. Note that the interchangeable lens 100 and the digital camera 200 according to the present embodiment are configured substantially similarly to those in the first embodiment. As such, the same constituent elements will be assigned the same reference signs, and redundant descriptions will be omitted, with the descriptions focusing on the differences.

Correction Processing Regarding Lens Characteristics

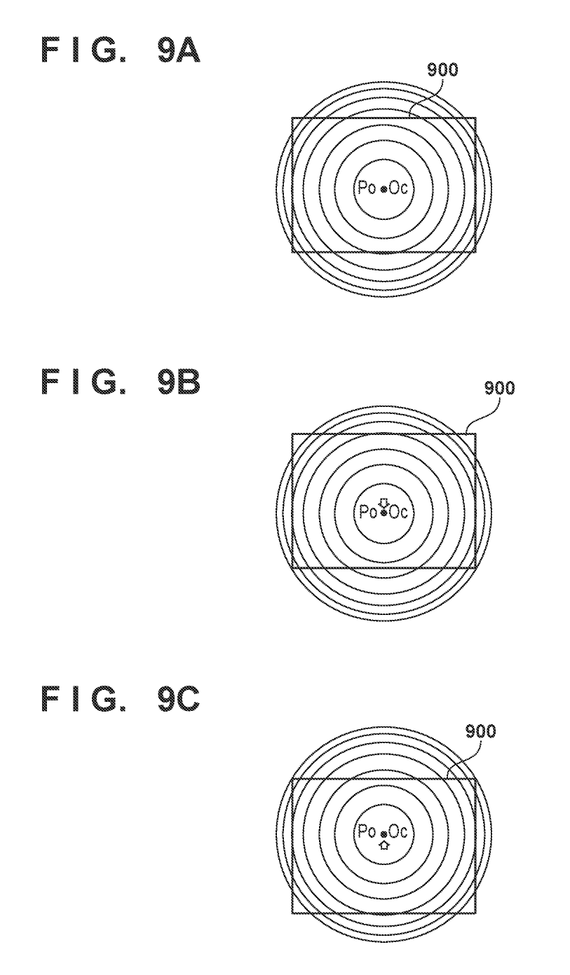

Because the correction parameter for distorted aberration can be represented as a concentric parameter with a correction center Oc as a reference, correction can be performed on each pixel according to the distance from the correction center Oc. For example, FIG. 9A schematically shows an example of distortion correction in the case where the camera shake correction lens 112 is fixed at a central position (position of optical axis). Circles with the correction center Oc as the center each indicate positions at which the same correction value is applied, and a larger correction value is applied as separating from the correction center Oc. In the example shown in FIG. 9A, distortion correction is performed on an image 900 with the optical axis center Po as a center. For example, the image processing circuit 261 reads out a predetermined correction value according to the distance from the correction center Oc from the internal memory 273, and performs correction processing on the peripheral portion of the image, and as a result, distortion can be prevented from occurring in the periphery of the image.

On the other hand, FIG. 9B schematically shows an example of distortion correction in the case where the optical axis of the camera shake correction lens 112 has been shifted downward by camera shake correction. When the camera shake correction lens 112 moves, optical aberration also changes, and as a result, distortion correction needs to be performed according to the position of the camera shake correction lens 112. That is, the correction center Oc in distortion correction needs to be changed according to the position of the camera shake correction lens 112.

In order to realize the correction shown in FIG. 9B, the image processing circuit 261 applies correction values such that the correction amount for a pixel on an upper side of the shooting region increases and the correction amount for a pixel on a lower side of the shooting region decreases (larger correction value is applied as separating from the correction center Oc). With this processing, the image on the upper side of the shooting region extends more, and the image on the lower side of the shooting region extends less.

FIG. 9C shows an example of distortion correction in the case where the optical axis of the camera shake correction lens 112 has been shifted upward by camera shake correction. As described above, because the correction center Oc in distortion correction changes according to the position of the camera shake correction lens 112, the image processing circuit 261 applies correction values such that the correction amount for a pixel on an upper side of the shooting region decreases and the correction amount for a pixel on a lower side of the shooting region increases. With this processing, the image on the upper side of the shooting region extends less, and the image on the lower side of the shooting region extends more.

As a result of determining the distortion correction parameter according to the position of the camera shake correction lens 112, in this way, the expansion/contraction of an image due to optical aberration can be corrected. Note that a case has been described where camera shake correction is performed by driving the camera shake correction lens 112 in the example described above, but the method can also be applied to a case where the position of the image sensor 251 is changed.

Correction Processing Regarding Lens Characteristics According to Position of Camera Shake Correction Movable Unit

Correction regarding lens characteristics in the second embodiment is distortion correction based on positions of the camera shake correction lens 112 and the image sensor 251.

First, the system controller 221 executes processing in steps S901 to S903 described above, and obtains the position of the image sensor 251, the position of the camera shake correction lens 112, and the position of the optical axis. Thereafter, the image processing circuit 261 obtains the distortion correction parameter based on the position of the image sensor 251 and the estimated position of the camera shake correction lens 112, from these results, and corrects the distorted aberration. Note that, in the case where a plurality of driving apparatuses for camera shake correction are present, as in the present embodiment, there are cases where the marginal illumination characteristics differ depending on the driving apparatus. In this case, a table in which distortion correction parameters are determined in advance according to the position of the correction center Oc is provided for each of the image sensor 251 and the camera shake correction lens 112, and correction processing regarding lens characteristics may be performed according to the respective positions, for example. The system controller 221, upon the image processing circuit 261 completing the processing for correcting marginal illumination, ends the correction processing regarding lens characteristics.

In the present embodiment, as described above, even in a case where the interchangeable lens 100 and the digital camera 200 each perform camera shake correction, the correction regarding lens characteristics can be appropriately performed without being influenced by a delay time in communication therebetween. Furthermore, even in a case where the camera shake correction apparatus is not included in the digital camera, or in a case where the camera shake correction apparatus on the interchangeable lens side is used without driving the camera shake correction apparatus on the digital camera side, the camera main body can preferably perform correction regarding the lens characteristics.

### OTHER EMBODIMENTS

In the embodiments described above, descriptions have been given in which marginal illumination and distorted aberration are taken as an example of the lens characteristics, but the above-described embodiments can also be similarly applied to correct magnification chromatic aberration, coma aberration, and the like.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-027249, filed Feb. 19, 2018, which is hereby incorporated by reference herein in its entirety.

What is claimed is:

1. An image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, comprising:
a second shake detection sensor that detects shaking;
an estimation circuit that estimates a shake correction amount to be used by the first image stabilization apparatus based on a shake signal from the second shake detection sensor; and
a lens characteristics correction circuit that performs correction regarding lens characteristics in an image signal obtained by image-capturing in a state in which the first image stabilization apparatus has corrected shaking, based on the estimated shake correction amount.

2. The image capturing apparatus according to claim 1, further comprising:
a second image stabilization apparatus that corrects shaking by moving an image sensor by a shake correction amount based on a shake signal from the second shake detection sensor,
wherein the lens characteristics correction circuit performs correction regarding lens characteristics in an image signal obtained by image-capturing in a state in which the first image stabilization apparatus and the second image stabilization apparatus have corrected shaking, based on the estimated shake correction amount and a shake correction amount based on a shake signal from the second shake detection sensor.

3. The image capturing apparatus according to claim 2,
wherein the estimation circuit estimates a shake correction amount that the first image stabilization apparatus uses based on a first shake signal obtained by separating a shake signal from the second shake detection sensor using a predetermined separation method, and
wherein the second image stabilization apparatus uses a shake correction amount that is based on a second shake signal obtained by separating the shake signal from the second shake detection sensor using the predetermined separation method.

4. The image capturing apparatus according to claim 3, further comprising:
a communication circuit that communicates the predetermined separation method with the interchangeable lens,
wherein, when the predetermined separation method that is communicated by the communication circuit has been changed from a first separation method to a second separation method, a shake signal from the second shake detection sensor is separated using the second separation method.

5. The image capturing apparatus according to claim 2,
wherein the estimation circuit estimates a shake correction amount to be used by the first image stabilization apparatus based on a low frequency component, of a shake signal from the second shake detection sensor, that is lower than a predetermined frequency,
wherein the second image stabilization apparatus uses a shake correction amount that is based on a high frequency component of the shake signal, from the second shake detection sensor, that is equal to or higher than the predetermined frequency, and
wherein the lens characteristics correction circuit performs correction regarding lens characteristics in an image signal obtained by image-capturing, based on a shake correction amount based on the low frequency component and a shake correction amount based on the high frequency component.

6. The image capturing apparatus according to claim 2,
wherein the estimation circuit estimates a shake correction amount that is to be used by the first image stabilization apparatus based on a high frequency component, of a shake signal from the second shake detection sensor, that is equal to or higher than a predetermined frequency,
wherein the second image stabilization apparatus uses a shake correction amount based on a low frequency component, of the shake signal from the second shake detection sensor, that is lower than the predetermined frequency, and wherein the lens characteristics correction circuit performs correction regarding lens characteristics in an image signal obtained by image-capturing based on a shake correction amount based on the high frequency component and a shake correction amount based on the low frequency component.

7. The image capturing apparatus according to claim 2, wherein the lens characteristics correction circuit applies a correction value that increases as a distance, from a reference point, of movement according to a sum of the estimated shake correction amount and a shake correction amount that is based on a shake signal from the second shake detection sensor increases.

8. The image capturing apparatus according to claim 2,
wherein the interchangeable lens comprises at least one of optical members of a zoom lens, a focus lens, and an aperture, and
wherein the lens characteristics correction circuit adjusts the estimated shake correction amount based on a state of the at least one of optical members.

9. The image capturing apparatus according to claim 1, wherein the estimation circuit estimates a shake correction amount to be used by the first image stabilization apparatus based on a low frequency component, of a shake signal from the second shake detection sensor, that is lower than a predetermined frequency.

10. The image capturing apparatus according to claim 1, wherein the estimation circuit estimates a shake correction amount that is to be used by the first image stabilization apparatus based on a high frequency component, of a shake signal from the second shake detection sensor, that is equal to or higher than a predetermined frequency.

11. The image capturing apparatus according to claim 1, wherein the estimation circuit estimates a shake correction amount to be used by the first image stabilization apparatus based on a signal obtained by separating a shake signal from the second shake detection sensor at a predetermined ratio.

12. The image capturing apparatus according to claim 1, wherein the lens characteristics correction circuit applies a correction value that increases as a distance, from a reference point, of movement according to a shake correction amount increases.

13. The image capturing apparatus according to claim 1, wherein the lens characteristics in an image signal obtained by image-capturing includes at least any of marginal illumination, distorted aberration, magnification chromatic aberration, and coma aberration.

14. A control method of an image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, comprising:
detecting shaking using a second shake detection sensor;
estimating a shake correction amount to be used by the first image stabilization apparatus based on a shake signal from the second shake detection sensor; and
performing correction regarding lens characteristics in an image signal obtained by image-capturing in a state in which the first image stabilization apparatus has corrected shaking, based on the estimated shake correction amount.

15. A non-transitory computer-readable storage medium storing a program for causing a computer to execute a control method of an image capturing apparatus to which an interchangeable lens comprising a first shake detection sensor that detects shaking and a first image stabilization apparatus that corrects shaking by moving an optical system by a shake correction amount based on a shake signal from the first shake detection sensor can be attached, the control method comprising:
detecting shaking using a second shake detection sensor;
estimating a shake correction amount to be used by the first image stabilization apparatus based on a shake signal from the second shake detection sensor; and
performing correction regarding lens characteristics in an image signal obtained by image-capturing in a state in which the first image stabilization apparatus has corrected shaking, based on the estimated shake correction amount.
